(19) United States
(12) Patent Application Publication
(10) Pub. No.: US 2011/0233810 A1
(43) Pub. Date: Sep. 29, 2011

(54) ANTIMICROBIAL PLASTIC COMPOSITIONS AND METHODS FOR PREPARING SAME

(75) Inventors: Dennis V. Neigel, Salisbury, NC (US); Edwin R. Loder, Boynton Beach, FL (US); Michael Dvorak, Oakland, TN (US)

(73) Assignee: W. M. Barr & Company, Memphis, TN (US)

(21) Appl. No.: 12/731,894

(22) Filed: Mar. 25, 2010

(51) Int. Cl. C08F 8/00; C08L 67/00; C08L 69/00; B29C 35/04

(52) U.S. Cl. 264/83; 525/342; 525/418; 525/461; 525/417; 523/122

(57) ABSTRACT

An antimicrobial plastic composition suitable for any non-foamed application includes an antimicrobial compound uniformly dispersed in a plastic. The antimicrobial compound is selected from the group consisting of silanol quaternary ammonium compounds and salts thereof (SQACs) having a hydroxyl or hydrolyzable silane group capable of undergoing a condensation polymerization reaction to form a homo or copolymer, and/or forming a covalent bond with the plastic and/or other components in the plastic composition. Also described are methods for preparing an antimicrobial plastic composition including: (i) uniformly dispersing an antimicrobial compound in a plastic; (ii) forming a shaped article; and (iii) optionally exposing the shaped article obtained in (ii) to moisture or steam. The antimicrobial plastic composition can provide an article which is non-leaching, environmentally safe, non-toxic, with surface renewability, durable antimicrobial properties and also has improved physical and chemical properties such as tensile strength, static dissipation and chemical resistance.

### TECHNICAL FIELD

The present invention relates to silanol quaternary ammonium compounds and their salts and a method of inhibiting the growth of bacteria and fungi by using the same. In particular, the invention relates to the use of such compounds as antimicrobial agents when dispersed or dissolved in plastics and polymerized to form totally non-leaching, low toxicity antimicrobial plastics for textile yarn or any other non-foamed applications where plastics are used.

### SUMMARY

In one embodiment, an antimicrobial plastic composition comprises an antimicrobial compound uniformly dispersed in a plastic, wherein the antimicrobial compound is selected from the group consisting of silanol quaternary ammonium compounds and salts thereof (SQACs) having a hydroxyl or hydrolyzable silane group capable of undergoing a condensation polymerization reaction to form a homo or copolymer and/or forming a covalent bond with the plastic and/or other components in the plastic composition, which optionally forms a homo or copolymer, and/or a covalent bond with the plastic and/or other components.

In another embodiment, a method for preparing an antimicrobial plastic composition comprises: (i) uniformly dispersing an antimicrobial compound in a plastic; (ii) forming a shaped article; and (iii) optionally exposing the shaped article obtained in (ii) to moisture or steam. The antimicrobial compound is selected from the group consisting of silanol quaternary ammonium compounds and salts thereof (SQACs) having a hydroxyl or hydrolyzable silane group capable of undergoing a condensation polymerization reaction to form a homo or copolymer and forming a covalent bond with the plastic and/or other components in the plastic composition.

In yet another embodiment, a method for preparing an antimicrobial plastic composition includes: (i) preparing a graft polymer by mixing a polymer with an antimicrobial compound, a vinyl or acrylic alkoxysilane, and a peroxide, (ii) preparing a master batch concentrate by mixing the polymer with a condensation catalyst, (iii) uniformly mixing the master batch concentrate and the graft polymer and thermoforming the mixture into a shaped article, and (iv) optionally exposing the shaped article obtained in (iii) to moisture or steam. The antimicrobial compound is selected from the group consisting of silanol quaternary ammonium compounds and salts thereof (SQACs) having a hydroxyl or hydrolyzable silane group capable of undergoing a condensation polymerization reaction to a homo or copolymer and forming a covalent bond with the plastic and/or other components in the plastic composition.

### DETAILED DESCRIPTION

A biocide is any substance that kills microorganisms such as bacteria, molds, algae, fungi or viruses. A biostatic is any substance that inhibits the growth of these organisms. The collective group of biocide and biostatic is called antimicrobials. People have been utilizing antimicrobials, commonly called preservatives, since they first discovered a need to extend the useful life of their food as well as their possessions. Sea salt may have been the first antimicrobial used to preserve food. The mummification techniques employed by early Egyptians used to preserve the human and animal body used salts and a variety of resins. These preservatives were thought to possess magical powers, as well as the ability to install qualities of eternal life.

The existence of microorganisms in nature was discovered in the late 1600 with the invention of the microscope. As early as 1705, mercuric chloride was used to preserve ships' planking against shipworm. It was not until the 19^{th} century discoveries by Pasteur, Gram and others that the causative agents of microbiological deterioration were understood, although use of antimicrobials in a cause and effect relationship with microorganisms is less than a century old.

Synthetic polymers and resins, including those used to make textile yarn are known to be subject to attack by microorganisms. Such microorganisms include bacteria, fungi and actinomycetes. Actinomycetes are microorganisms found in soil and contain no chlorophyll. They are usually classified with the bacteria, but resemble both bacteria and fungi. Such microorganisms attack polymers and resins, causing damage or deterioration ranging from discoloration and staining to embrittlement or disintegration.

In addition to physical deterioration of polymers and resins, microorganisms growing on the surface of such materials can cause discoloration and/or staining thereof resulting in shortening of the useful life of said materials for at least aesthetic purposes. Actinomycetes, in particular, growing on the surfaces of polymers and resins can produce colored byproduct dyes which are soluble in the plasticizers used in such substances, and which migrate through the substance via the plasticizer, resulting in the phenomenon known as “pink staining.”

A number of properties are required for suitable performance of an antimicrobial compounded in plastics: (1) antimicrobial effectiveness, (2) uniform distribution, (3) chemical stability, durability (non-leaching), (4) lack of negative effects on physical properties of the plastic, and (5) low human and environmental toxicity. See, for example, U.S. Pat. No. 2,490,100.

Such antimicrobial properties are necessary for plastics, including polymer/cellulose blends, which are cast, rolled, molded, or extruded. An antimicrobial compound can be used in the manufacture of plastic articles, or as plastic coatings, as well as in plastics which are knitted or woven into continuous fibers for textiles.

Many of the industrial biocides currently used in connection with plastics are organometallics of copper, tin, zinc or mercury. Copper-8-quinolinolate provides the required antimicrobial performance; however, it was not accepted by civilian industry owing to its leachable green color. In addition, organometallics may be suspect for reasons of toxicity or environmental effect and problems caused by their handling and are now less accepted in some of the industrial uses in which they have hitherto been employed.

To counter the high toxicity of organometallics, biocides based on organoarsenic, cyanide derivatives and chlorinated phenolics were developed. In the 1960s, such biocides formulated for use specifically in plastics appeared on the market. Formulated products containing 10,10′-oxybisphenoxarsine (OBPA) are used specifically in the plastics industry and primarily for use in flexible polyvinyl chloride (PVC). See, for example, U.S. Pat. No. 3,689,449. For many years, OBPA maintained an uncontested position as the most successful antimicrobial for plastics worldwide as measured by sales and effectiveness at low usage levels (0.03-0.05%). OBPA concentrates dissolved in both plasticizers and plastics for resin compounding are still available today as Rohm and Haas Vinyzene OBPA BP and SB series biocides. However, arsenic compounds are increasingly losing favor in applications where environmental toxicity through leaching can occur.

The most recent antimicrobial technology to be used in the textile industry is silver ion coating. In its simplest form, a coating system is formed by binding silver ions to a fine ceramic powder (zeolite) and dispersed in a carrier. The ions are then exchanged with sodium, calcium or other ions when the surface comes into contact with water or body fluids. Further developments, particularly in the area of nanotechnology, have enabled the use of silver technology in plastics, fabrics and coatings without the use of zeolite (see, for example, Wagener et al., Antimicrobial coatings by using nanosilver particles, the second Global Conference, 2004).

Uptake of silver ions by a microbe cell can occur by several mechanisms, including passive diffusion and active transport by systems that normally transport essential ions. While the silver ions may bind non-specifically to cell surfaces and cause disruptions in cellular membrane function, it is widely believed that the antimicrobial properties of silver depend on silver binding within the cell. Once inside the cell, silver ions begin to interrupt critical functions of the microorganism.

In addition, silver ions are highly reactive and readily bind to electron donor groups containing sulfur, oxygen and nitrogen, as well as negatively charged groups such as phosphates and chlorides. A prime molecular target for the silver ions resides in cellular thiol (—SH) groups commonly found in enzymes. The resultant denaturation of the enzymes incapacitates the energy source of the cell, thereby resulting in death of the microbe.

Problems with silver as an antimicrobial for synthetic textiles fibers include: the need for a latex binder that can survive multiple laundry detergency cycles while resisting depletion of sufficient silver to maintain efficacy, leaching into the environment as well as leaching on to the skin and high application cost.

All of the above antimicrobials have various degrees of human toxicity and pollute the environment through leaching and disposal of the plastic item itself into landfills. When these toxic plastics are recycled, there exists the potential of cross contamination of these antimicrobials into plastics with uses where toxic, leaching antimicrobials cannot be tolerated, such as plastics used for food contact and baby toys. Therefore, a worldwide need is clearly identified for an effective, non-toxic, non-leaching antimicrobial for inclusion in plastics.

### Covalent Bonding of Biocide to a Reactive Silicone Compound

Certain silanol quaternary ammonium compounds (SQACs) possess bacteriostatic, fungistatic and algaestatic and/or bactericidal, fungicidal and algaecidal properties. See, for example, U.S. Pat. Nos. 3,730,701; 3,817,739; and 4,394,378; and British Patent No. 1,386,876. For example, 3-(trimethoxysilyl)propyl octadecyldimethyl ammonium chloride is a commercial antimicrobial product marketed by Dow Corning as BIOGUARD Q 9-5700 (EPA No. 34292-1). U.S. Pat. No. 3,794,736 describes a number of other organosilicon amines and salts thereof exhibiting antimicrobial activity on a wide variety of microorganisms.

This technology utilizes the properties of reactive silanols and their ability to bond with a target surface. The mechanism of cure involves a reaction with water to change alkoxysilane groups into hydroxysilane groups. Through condensation polymerization the reactive hydroxysilane groups can form covalent bonds with any surface containing hydroxides or oxides in any form, including on the surfaces of metals (including stainless steel). In addition, silanol groups can homopolymerize via this condensation mechanism to form a durable, water-insoluble three dimensional crosslinked polymer matrix. The application of heat during the cure can speed up these condensation reactions which can also take place at room temperature, but at a slower rate. The application of silanol compounds is therefore very versatile and can be used to treat many types of surfaces, such as plastic, wood, ceramic, metal, fabric and painted surfaces.

In the silanols modified with biocidal adjuncts, e.g., in the form of alkyl quaternary ammonium groups, when the silanols fix onto a surface, the active biocidal sites also become fixed. The films thus created are extremely thin, between 15 nm and 180 nm, and therefore the original physical properties of the surface are little affected.

Bacteria arriving on the surface encounter the hydrocarbon portion of the biocidal adjunct that may be assimilated into the cell without any disruption. However, contact with the positively charged nitrogen atom of a silanol quaternary ammonium compound can unbalance the electrical equilibrium within the porin channels and on the outer protein layers such that the cells can no longer function properly and the microbes die.

The fixed nature of the biocide is important where toxicity, taint and other organoleptic aspects are of concern. This bactericidal surface treatment is not removed by normal cleaning procedures. In fact, it is important to maintain the normal cleaning regime in order to “refresh” the biocidal surface. The thinness of the film enables application in areas where optical properties are important, such as for treatment of contact lenses. The technology has been used for treatment of bed sheets, hospital garments (see, for example, Murray et al., Microbial inhibition on hospital garments treated with Dow Corning 5700 antimicrobial agent, Journal of Clinical Microbiology, 26, 1884-86, 1988), curtains, floor and wall materials, air filtration systems, medical devices, bandages, surgical instruments and implants (see, for example, Gottenbos et al., In vitro and in vivo antimicrobial activity of covalent coupled quaternary ammonium silane coatings on silicone rubber, Biomaterials, 23, 1417-1423, 2002). This technique has been used to prevent biofilm growth on catheters, stents, contact lenses and endotracheal tubes.

Silanol quaternary ammonium compounds (SQACs), when surface treated to form a covalent bonded film on synthetic textile yarn, may lose antimicrobial effectiveness upon multiple laundry detergency testing cycles (LDTs). This is due to attrition, bleaching and the action of anionic detergents to form a polymer coacervate with the SQACs, although this may take many LDTs before the antimicrobial coating is rendered ineffective.

The EPA's 2007 environmental fate assessment ruling on SQAC as stated in EPA's Pesticide Docket #EPA-HQ-OPP-2007-0831 states that “The Agency has conducted an environmental fate assessment dated Sep. 19^{th}, 2007 for the trimethoxysilyl quaternary ammonium compounds (quats). The hydrolysis data indicate that the trimethoxysilyl quats are soluble but not stable in water. Environmental fate studies for the trimethoxysilyl quats consist of only a hydrolysis study and it was concluded by the Agency that no further fate studies would be required because of the instability of the compounds and their formation of an insoluble silane degradate. The trimethoxysilyl quats are not expected to contaminate surface or ground water due to rapid degradation by hydrolysis.”

The EPA's 2007 toxicity ruling on SQAC as stated in the same EPA's Pesticide Docket #EPA-HQ-OPP-2007-0831 states that “Upon reviewing the available toxicity information, the Agency has concluded that there are no endpoints of concern for repeated oral or dermal exposure to the trimethoxysilyl quats. This conclusion is based on low toxicity observed in acute, subchronic and developmental studies conducted with the trimethoxysilyl quat compounds. There are no concerns for carcinogenicity for the trimethoxysilyl quats based on the results of the mutagenicity studies and the lack of any systemic toxicity being observed in the toxicity data base; therefore, no carcinogenic analysis is required.”

Below is a table comparing the toxicity of SQAC to the best selling biocidal plastic additive, an organic arsenic compound, 10,10′-oxybisphenoxarsine (OBPA):

TABLE I
Toxicity of SQAC vs. OBPA

Result

| Test | Species | SQAC | OBPA |
|---|---|---|---|
| Oral LD50 | Rat | >5000 mg/kg | 37 mg/kg |
| Dermal LD50 | Rabbit | >2000 mg/kg | 121 mg/kg |

In the EPA report “OBPA: Human Health Assessment Scoping Document in Support of Registration Review” dated Sep. 1^{st} 2009, the overall toxicity conclusion is that “The (EPA) Antimicrobial Division has reviewed the hazard and exposure databases for OBPA. The division anticipates that additional toxicity and exposure data will be needed for OBPA. Toxicology data are needed to address subchronic, developmental and reproductive toxicity as well as mutagenic potential. In addition, metabolism data are needed to characterize the disposition and biotransformation of OBPA when ingested.”

In the EPA report “OBPA Registration Review Decision; Environmental Fate and Ecological Effects Summary”, a supporting document for the above, states that “The Agency has no acceptable environmental fate data on OBPA,” and that “An extractability study conducted on heavy gauge vinyl pool liner and a film of vinyl baby pants was reviewed by the Agency and showed that OBPA leaches very slowly from (these) plastics.” Leaching of such class 1 poisons to environment is at least irresponsible even at sub-lethal concentrations and may also give rise to new, more resistant microbes such as is the case of methicillin-resistant Staphylococcus aureus (MRSA).

Compared to OBPA, the leading antimicrobial plastics application, SQACs are extremely low in toxicity and have an acceptable environmental fate. SQACs are capable of surviving many laundry detergency cycles when surface coated on synthetic polymers and plastics for textiles.

SQAC antimicrobial compounds have been effectively used since 1960 to treat a variety of surfaces including wood, painted surfaces, concrete, grout, metal, ceramics, plastics and textiles with good success. However, these treatments have invariably been applied topically as dilute solutions by spray, brush, dip or padding techniques, followed by evaporation of the solvent, usually water, to effect a cure of the SQAC. Although the cured SQAC polymer surface coating is a crosslinked matrix, it is often less durable than the substrate to which it is applied and is prone to mechanical wear or harsh, abrasive chemical cleaning. Once the surface coating is worn off, all antimicrobial protection is lost. In certain embodiments of this invention, SQAC is uniformly incorporated throughout a plastic composition or article, thus eliminating wear related antimicrobial failure as seen from surface coatings. As wear occurs, the article can continuously expose a new surface containing the same antimicrobial concentration as when it was new, affording antimicrobial protection for the lifetime of the article. Examples include any articles that are exposed to continuous wear including, but not limited to, conveyer belts, deck planking, rope, tires, toilet seats and certain personal items.

Non-silicon containing quaternary ammonium compounds have been incorporated into plastics in the past, however, these biocides are generally used in coatings and films. See, for example, U.S. Pat. No. 6,979,455. However, when the plastics are processed at high temperatures, such as extrusion and injection molding, discoloration and loss of activity of the biocides occur.

The present inventors discovered that silicon containing quaternary ammonium compounds such as those described and used in this invention, have unique and unexpected advantages of greater heat stability than their non-silicon containing counterparts. Therefore, certain embodiments of this invention demonstrate that these SQACs are suitable for use in high temperature processes, for example, extrusion and injection molding processes, of resins having high melting points, such as Nylon and PET, without any significant discoloration and loss of activity.

Described herein are antimicrobial plastic compositions and methods for producing the same. The antimicrobial plastic composition comprises an antimicrobial compound uniformly dispersed in a plastic, wherein the antimicrobial compound is selected from the group consisting of silanol quaternary ammonium compounds and salts thereof (SQACs) having a hydroxyl or hydrolyzable silane group capable of undergoing a condensation polymerization reaction to form a homo or copolymer as well as a covalent bond with the plastic and/or other components in the plastic composition, which optionally forms a homo or copolymer, and/or a covalent bond with the plastic and/or other components. Certain embodiments of this invention demonstrate improved antimicrobial protection of plastics, as well as improved durability and longevity of antimicrobial effectiveness of SQACs in all non-foamed plastic articles produced by the teachings of this invention.

The term “plastic” or “plastics”, as used herein, denotes a synthetic, thermoplastic or thermosetting polymer and/or resin, or a synthetic/natural composite thereof. The term “non-foamed plastic”, as used herein, denotes plastics which are not foamed or not formed into non-filled stable foams or articles made thereof, or plastics otherwise provided with closed or open gas cells therein.

The method comprises dispersing the SQAC uniformly throughout the plastic, for example, by compound extrusion processing of such plastic when in a fluid state. Common equipment used for such compounding are single and twin screw extruders, compound injection molders, Banbury mixers and Henschel dispersers. The dispersion process uses SQAC, either neat or predispersed in plasticizers or pigments commonly used in plastic extrusion processes, or in a form of master batch concentrate. Alternately, this dispersion process is done in solvent followed by evaporation of the solvent, then cast, molded or rolled into a desired form. The result is a plastic that has both surface and interior antimicrobial protection from a totally non-leaching, non-toxic polymeric SQAC compound.

Examples of suitable plastics used in the composition and compounding of this invention for all non-foamed applications include, but are not limited to, polyolefins such as polyethylene, polypropylene and polybutylene; polyethylene/acrylate copolymers such as ethylene methyl acrylate; polyesters such as polyethylene terephthalate and polybutylene terephthalate; polyamides such as Nylon 6, Nylon 6,6, Nylon 4,6, Nylon 11, Nylon 12, and aramids; polyacrylate homo and copolymers such as polymethylmethacrylate; polyethers such as polyether sulfone and polyetheretherketone; phenoxy polymers such as epichlorohydrin/bisphenol resins; polystyrene and copolymers such as ABS; polyacetal (polyoxymethylene) homo and copolymers; polycarbonate; polyethylene naphthalate; polyamide/imide; polybenzimidazole; fluoropolymers such as ethylene-chlorotrifluoroethylene; synthetic rubbers such as ethylene/propylene/diene monomer (EPDM); chlorinated rubber; nitro rubber; styrene butadiene rubber; polyurethanes; polylactides; vinyl polymers such as polyvinyl acetate and copolymers, polyvinyl butyral, and polyvinyl chloride; cellulose derivatives such as cellulose acetate and copolymers with cellulose propionate and cellulose butyrate, nitro cellulose; Rayon; and all physical blends of any of the above.

For extruded filament and fibers used in synthetic textile yarn manufacture, both woven and non-woven, some of the organic polymers which can be used in the compounding and compositions of this invention and their uses in textiles are listed below:
Polyester fiber is used in all types of clothing, either alone or blended with fibers such as cotton,
Aramid fiber (e.g., TWARON) is used for flame-retardant clothing, cut-protection, and armor.
Acrylic is a fiber used to imitate wool, including cashmere, and is often used in replacement of them.
Nylon is a fiber used to imitate silk; it is used in the production of pantyhose. Thicker nylon fibers are used in rope and outdoor clothing.
Spandex (trade name LYCRA) is a polyurethane fiber that stretches easily and can be made tight fitting without impeding movement. It is used to make active wear, bras, and swimsuits.
Olefin is a fiber used in active wear, linings, and warm clothing. Olefins are hydrophobic, allowing them to dry quickly. A sintered felt of olefin fiber is sold under the trade name TYVEK.
Ingeo is a polylactide fiber blended with other fibers such as cotton and used in clothing. It is more hydrophilic than most other synthetics, allowing it to wick away perspiration.

Some of the specific examples of suitable organic polymers which can be used in compounding and compositions of this invention, including common brand names and non-foamed uses, are listed below:

### Polyacrylonitrile-butadiene-styrene (ABS)

Common Brand Names : CYCOLAC, LUSTRAN, NOVODUR, RONFALIN;
used to make light, rigid, molded items such as plastic pipe, musical instruments, golf club heads automotive body parts, wheel covers, enclosures, protective headgear, buffer edging for furniture and joinery panels.

### Polyoxymethylene—Copolymer

(Acetal—Copolymer POMC)
Common Brand Names: CELCON, HOSTAFORM, KEMETAL, ULTRAFORM;
used in applications where low water absorbance and resistance to base hydrolysis are needed.

### Polyoxymethylene—Homopolymer

(Acetal—Homopolymer POMH)
Common Brand Names: DELRIN, TENAC;
used in precision parts that require high stiffness, low friction and excellent dimensional stability such as plastic ball bearings.

### Polymethylmethacrylate (PMMA, Acrylic)

Common Brand Names: DIAKON, LUCITE, OROGLAS, PERSPEX, PLEXIGLAS;
used as an alternative to glass.

### Cellulose Acetate (CA)

Common Brand Names : CLARIFOIL, DEXEL, TENITE ACETATE;
used as a film base in photography, as a component in some adhesives, as a frame material for eyeglasses, as a synthetic fabric and in the manufacture of cigarette filters.

### Cellulose Acetate Butyrate (CAB)

Common Brand Names: CELLIDOR B, TENITE BUTYRATE;
used in packaging tubes, backlighted signs, machine guards and glazing.
   Ethylene-Chlorotrifluoroethylene copolymer (E-CTFE);
Common Brand Name: HALAR;
Used in cams, ball bearings, valve seats, semiconductor tooling, and electrical insulators for wire and cable.

### Polyamide—Nylon 4,6 (PA 4,6)

Common Brand Names: STANYL;
used in automotive and electronics applications offering good mechanical properties at high temperatures and excellent resistance to wear.

### Polyamide—Nylon 6 (PA 6)

Common Brand Names: AKULON K AND F, CAPRON, MARANYL B, NYLACAST, ORGAMID, ULTRAMID B;
used for bristles for toothbrushes, sutures for surgery, manufacture of hosiery, knitted garments, a large variety of threads, ropes, filaments, nets, tire cords, strings for acoustic and classical musical instruments, including guitar, violin, viola, and cello.

### Polyamide—Nylon 6,6 (PA 6,6)

Common Brand Names: AKULON S, MARANYL A, UTRAMID A, ZYTEL;
used in carpet fiber, apparel, airbags, tires, ropes conveyor belts and hoses.

### Polyamide—Nylon 11 (PA 11)

Common Brand Names: RILSAN B;
used in high-performance applications such as automotive fuel lines, pneumatic airbrake tubing, electrical anti-termite cable sheathing, oil and gas flexible pipes and control fluid umbilicals, sports shoes, electronic device components, and catheters.

### Polyamide—Nylon 12 (PA 12)

Common Brand Names: RILSAN A, VESTAMID;
used where very high impact resistance and good wear resistance are required. Because of its low absorption of moisture the material has highly stable dimensions and mechanical properties.

### Polyamide/imide (PAI)

Common Brand Names: KERIMID, TORLON;
used in injection or compression molded parts, and coatings, films, fibers and adhesives requiring high mechanical, thermal and chemical resistant properties. These properties put polyamide-imides at the top of the price and performance pyramid.
   Polyaramid—(Polyparaphenylene terephthalamide)
Common Brand Names: KEVLAR, TWARON;
used in aerospace and military applications, for ballistic rated body armor fabric, and as an asbestos substitute.
   Polyaramid—(Polymetaphenylene isophthalamide)
Common Brand Names: NOMEX;
used in fire resistant suits, circuit boards and transformer cores.

### Polybenzimidazole (PBI)

Common Brand Names: CELAZOLE;
used in high temperature applications such as aerospace, aircraft, electrical/electronics, insulation and valves.
   Polybutylene terephthalate (PBT)
Common Brand Names : CELANEX, ORGATER, VALOX; used as an insulator in the electric and electronics industries.

### Polycarbonate (PC)

Common Brand Names: LEXAN, MAKROFOL, MAKRO;
used in compact discs, DVDs, Blu-Ray discs, drinking bottles, drinking glasses, lab equipment, research animal enclosures, lighting lenses, sunglass and eyeglass lenses, safety glasses, automotive headlamp lenses, laptops and computer cases and instrument panels.

### Polyetheretherketone (PEEK)

Common Brand Names: VICTREX, ZYEX;
used for bearings, piston parts, pumps, compressor plate valves, cable insulation, medical implants and extensively used in the aerospace, automotive, teletronic, and chemical process industries.

### Polyethersulfone (PES)

Common Brand Names: ULTRASON E, VICTREX;
used as a dielectric in capacitors and filtration media.
   Polyethylene naphthalate (PEN)
Common Brand Names: KALADEX;
used as very good oxygen barrier in beverage bottling, high performance photosystem film and high performance sailcloth (better dimensional stability than polyester or Nylon).

Below is a list of some common thermoplastic resins and their physical properties, including some of the temperatures at which they are extrusion and injection molded:

TABLE II

| | Extrusion | Injection | Mold | |
|---|---|---|---|---|
| | Temp | Temp | Shrinkage | Specific |
| Material | (° C.) | (° C.) | (inch) | Gravity |
| ABS | 225 | 260 | 0.005 | 1.03 |
| Acetal | — | 200 | 0.020 | 1.41 |
| Acrylic | 188 | 232 | 0.0045 | 1.17 |
| FEP | 315 | 315 | 0.010 | 2.11 |
| Nylon 6 | 277 | 288 | 0.013 | 1.13 |
| Nylon 6,12 | 246 | 260 | 0.011 | 1.07 |
| Polycarbonate | 288 | 302 | 0.011 | 1.20 |
| PBT | — | 238 | 0.02 | 1.34 |
| PET | 285 | 254 | 0.002 | 1.31 |
| HDPE | 210 | 249 | 0.025 | 0.955 |
| LDPE | 315 | 204 | 0.027 | 0.92 |
| Polypropylene | 232 | 254 | 0.018 | 0.91 |
| PVC-rigid | 193 | 193 | 0.025 | 1.29-1.4 |
| PVC-flexible | 185 | 149 | 0.025 | 1.23-1.37 |
| Polyurethane | 204 | 204 | 0.020 | 1.2 |

The antimicrobial SQACs, which can be used in the compounding and compositions of this invention, and their preparation are described in the literature. See, for example, U.S. Pat. Nos. 3,730,701; 3,817,739; 4,394,378; and 4,921,691; and British Pat. No. 1,433,303.

The essential characteristics of the SQACs are antimicrobial activity imparted by long chain alkyl group(s) on the quaternary nitrogen atom and hydroxyl or hydrolyzable groups on the silicon atom that can be reacted with plastics. The hydrolyzable group includes a hydrocarbonoxy group such as alkoxy or acyloxy, for reactions with active hydrogen of the plastic. In a water solution, alkoxy and acyloxy groups can be hydrolyzed to hydroxyl groups, thereby forming silanol, for reaction with the plastic.

Examples of suitable antimicrobial SQACs which can be used in the present invention include those represented by the following general Formulae I and II:

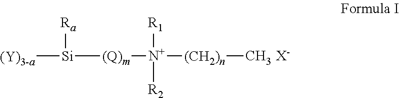

### Where:

Y is a hydroxyl or hydrolyzable radical, e.g., hydrocarbonoxy, e.g. alkoxy or acyloxy;
R is a hydroxyl or monovalent hydrocarbon group, e.g., lower alkyl or phenyl;
a is 0 or 1;
Q is a divalent hydrocarbon group, e.g., alkylene or phenylene wherein the alkyl chain in the alkylene may be interrupted by one or more phenylene groups;
m is an integer from 1 to 20, and preferably from 2 to 10;
R₁ is alkyl having from 1 to 30 carbon atoms;
R₂ is a lower alkyl having 1 to 8 carbon atoms;
n is an integer from 6 to 30; and
X is a monovalent inorganic or organic radical or group selected from halogen; triiodide radical; alkoxy or ZSO₄, where Z is a monovalent hydrocarbon, —(CH₂—)_{b}—R₃, —(CH₂O)_{d}(CH₂—)_{b}—R₃, —(CH₂—)_{b}—COOR₃, where b is an integer of 2 or more, and preferably from 2 to 24, d is an integer of 1 to 10, and R₃ is a monovalent hydrocarbon.

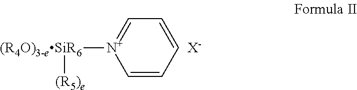

where:
R₄ is hydrogen or an alkyl having 1 to 4 carbon atoms;
e is an integer of 0 or 1;
R₅ is a lower alkyl, and preferably methyl or ethyl;
R₆ is an alkylene group of 1 to 4 carbon atoms; and
X is the same as defined in Formula I.

A lower alkyl, as used herein, represents alkyl having from 1 to 8 carbon atoms.

In a preferred embodiment, the SQACs are represented by the above Formula I, wherein:
Y is hydroxyl, methoxy or ethoxy;
a is 0 or 1;
R is methyl or ethyl;
Q is methylene;
m is 3;
m is 3;
R₁ is methyl or alkyl having 10, 14 or 18 carbon atoms;
R₂ is methyl; and/or
X is Cl.

Some representative, EPA registered SQACs particularly useful in the compounding and compositions of this invention include the following:

| Ref # | Chemical Name |
|---|---|
| (1) | 3-(trimethoxysilyl) propyl-N-octadecyl-N,N-dimethyl ammonium |
| | chloride |
| (2) | 3-(trimethoxysilyl) propyl-N-tetradecyl-N,N-dimethyl ammonium |
| | chloride |
| (3) | 3-(trimethoxysilyl) propyl-N,N-didecyl-N-methyl ammonium |
| | chloride |
| (4) | 3-(trihydroxysilyl) propyl-N-octyldecyl-N,N-dimethyl ammonium |
| | chloride |

TABLE III
Physical and Chemical Properties of EPA Registered SQACs

| Ref # | 1 | 2 | 3 | 4 |
|---|---|---|---|---|
| Empirical | C₂₆H₅₈ClNO₃Si | C₂₂H₅₀ClNO₃Si | C₂₇H₆₀ClNO₃Si | C₂₃H₅₂ClNO₃Si |
| formula | | | | |
| CAS # | 27668-52-6 | 41591-87-1 | 68959-20-6 | 199111-50-7 |
| OPP* code | 107401 | 107409 | 169160 | 107403 |
| Mol. Wt. | 496.30 | 440.31 | 510.3 | 454 |
| (g/mol) | | | | |
| Melting point | 267 | 245 | 272 | 306 |
| (° C.) | | | | |
| Boiling point | 617 | 570 | 628 | 702 |
| (° C.) | | | | |
| Vapor pressure | 5.8 × 10⁻¹⁴ | 1.7 × 10⁻¹² | 2.4 × 10⁻¹⁴ | 1.85 × 10⁻²¹ |
| (mmHg) | | | | |
| Specific gravity | 0.99 | 1.012 | 0.85 | 1.0 |

*EPA Office of Pesticide Protection Number

The above physical data were run on the monomeric forms of the SQACs. When these compounds are exposed to average room temperature and humidity, they can polymerize over time (e.g., several hours), or steam (e.g., at 350° F. for less than one minute), to form three dimensional crosslinked polymer chains having no vapor pressure and no water solubility. When the SQACs are incorporated into thermoplastic resins and polymerized by exposure to moisture or steam, they form a completely non-leaching, non-toxic antimicrobial network.

In certain embodiments, the SQAC is uniformly dispersed throughout a plastic, e.g., by compound extrusion processing of such plastic. Suitable equipment used for such compounding are, e.g., single and twin screw extruders, compound injection molders, BANBURY mixers and HENSCHEL dispersers. The result is a plastic composition that has both surface and interior antimicrobial protection.

In a further embodiment, the SQAC may be dispersed in the form of a fluid state, e.g., a melting state or a solution in a solvent. The above mentioned melting points are given as those of the pure monomeric SQACs, devoid of all solvents that would cause a melt point depression. It has been experimentally determined that small amounts of solvent, such as methanol, added to 3-(trimethoxysilyl) propyl-N-octadecyl-N,N-dimethyl ammonium chloride (SQAC Ref #1) can lower the melt point to the following ranges:

TABLE IV

| Methanol Added | Resultant Melt |
|---|---|
| (wt % on neat SQAC) | Range (° C.) |
| 0% | 267 |
| 1% | 120-165 |
| 3% | 70-115 |
| 5% | 35-60 |

The use of small amounts of methanol diluent, as listed above, to lower the melting range of the SQAC is a valuable tool to aid dispersion and improve uniformity of incorporation into the plastic at the temperature it is being compounded. For example, from Table I, when an acrylic resin is compound extruded at 188° C. where SQAC Ref #1 would not melt in neat form during the process, dispersion of the SQAC would not be as uniform as if the SQAC was liquefied. By adding or retaining 1% methanol (based on above Table IV), the SQAC would melt during the extrusion process and become better dispersed. The use of 5% methanol offers additional advantage of surface coating the resin chip with a spray of SQAC at 40° C. to 60° C., prior to compound extrusion. This method of distribution is particularly effective when lower levels of SQAC treatment (less than 1%) are being compounded. The larger amounts of methanol are then removed either by pre-drying the chip before extrusion, or by applying vacuum on a section of the extruder. Other suitable solvents include, but are not limited to, lower alkyl alcohols, such as ethanol and isopropanol. The amount of the solvent added can range from about 0.5 wt % to about 10 wt %, based on the weight of the SQAC, preferably from about 1 wt % to about 5 wt %.

The antimicrobial compound may be present in the plastic composition in an amount which is effective to prevent the plastic composition from microbial attack. In one embodiment, the antimicrobial compound is present in an amount ranging from about 0.01 wt. % to about 30 wt. %, preferably from about 0.25 wt. % to about 14 wt. %, based on the total weight of the plastic composition.

### Predispersed Antimicrobial Particles

Uniform dispersion of the SQAC in the plastic composition or the final plastic article is critical to both effective antimicrobial protection and the physical properties of the end use article. For example, polyethylene terephthalate (PET) used for spinning continuous fibers for knitting yarn needs to maintain the tensile strength after it is treated with SQAC to prevent filament breakage as it is being spun or extruded.

In certain embodiments of this invention, the SQAC can be dispersed in the plastic in the form of a predispersed mixture with an inert powdered additive, such as plasticizers and pigments, which can be used in resin extrusion processes and in the end article. The powdered additive may have an average particle size ranging from submicron to several millimeters, depending on applications. In the formed predispersed particles, the powdered additive can be at least partially coated with the SQAC. This technique can aid dispersion of the SQAC into the plastic, thereby providing improved uniform distribution of the SQAC.

For example, a powdered pigment, such as titanium dioxide powder, can be pre-dispersed into a 70 wt. % methanolic solution of SQAC Ref #1, then the methanol can be stripped off, yielding a free flowing powder that can be easily dry blended with the resin chip or co-fed into a feed hopper of an extruder. When TiO₂ is not used, the methanol stripped SQAC Ref #1 sets to a waxy solid at room temperature and is extremely difficult to co-feed uniformly during extrusion. In addition to TiO₂ powder, other powdered dispersion aids, such as calcium sulfate, calcium carbonate, talc, carbon black, carbon fibers, cellulosic fibers, powdered dyes and pigments, antioxidants or any powdered additives used in thermoplastic resin extrusion formulations can be used as dispersion aids for SQAC described herein.

Many plasticizers in plastics are known to be susceptible to microbiological attack, and their susceptibility relates to their migration rate. Plasticized polyvinyl chloride (PVC) is the plastic most vulnerable to attack followed by the ester linked polyurethanes, probably through the easy hydrolysis of the ester group. Therefore, the use of an SQAC/plasticizer premix not only provides improved dispersion and ease of handling, it eliminates any possibility of plasticizer based microbial growth and may also reduce plasticizer migration.

In particular, plasticizers with poor antimicrobial resistance that would benefit from SQAC protection include butyl lautate, ethylene glycol laurate, ethylene glycol ether laurate, diethylene glycol monolaurate, diethylene glycol ehtyl ether laurate, glycerol laurate, sorbitol laurate, dibutyl ammonium oleate, methyl acetal ricinoleate, butyl acetal ricinoleate, glycerol monoricinoleate, stearic acid and butoxyethyl stearate.

Examples of plasticizers that have shown good antimicrobial resistance include, but are not limited to, various diesters of adipic and phthalic acids. SQAC has good dispersibility with many of the above plasticizers, either in a neat form or containing small amounts of suitable solvent, such as methanol, to reduce the melt point. Each SQAC/plasticizer/diluent system can provide a unique balance of each ingredient that renders the best overall solubility and uniform distribution of both the SQAC and plasticizer in the plastic being compounded. This balance can be optimized through experimentation, so this optimization is left to those skilled in the art and with the knowledge of a particular system's requirements. In addition, improved color of the plastic composition or the final plastic article can be obtained when SQAC is premixed with a plasticizer.

The pigment or plasticizer can be added in an amount effective to improve dispersion of the SQAC in the SQAC-containing plastic composition. In one embodiment, the SQAC is premixed with a pigment or plasticizer in an amount of about 30 to about 70 wt. %, preferably about 40 to about 60 wt. %, and more preferably about 45 to about 55 wt. %, based on the total weight of the SQAC and the pigment or plasticizer.

The predispersed antimicrobial/additive mixture can be processed into particles, such as pellets suitable for injection molding or fiber spinning, having an average particle size ranging from submicron to several millimeters, depending on applications.

### Master Batch Concentrates

In certain embodiments of this invention, SQAC in a final thermoformed (extruded, injection molded, melt spun, etc.) article can be first compounded into a resin at much higher concentrations than needed in the final thermoformed article, thereby providing master batching or master batch concentrates. These concentrates are then blended and thermoformed with virgin resin chip at the ratio needed to provide the predetermined concentration of SQAC in the final article. Biocidal resin concentrates or master batching provide a safer and more uniform way to incorporate biocides into plastic articles during the compounding process. See, for example, U.S. Pat. No. 4,789,692.

This technique further improves uniform distribution of SQAC in the plastic and is particularly convenient for an end user performing the final processing because all the compounding of the SQAC into the resin chip has already been done and the end user is merely blending a predetermined ratio of virgin resin chip and a master batch concentrate. In many cases in the textile industry, master batch concentrates are the only acceptable way an end use extrusion facility uses such additives in their process.

In one embodiment, the concentration of the SQAC in the master batch concentrates may be at least 20 times higher than the concentration in the plastic composition or the end use article. When the concentration of SQAC is lower than this, excessive amounts of resin must be pre-processed to contain sufficient amount of SQAC, leading to extra expense. On the other hand, the upper concentration limit of SQAC in the master batch concentrate may be at most 100 times higher than the concentration in the end use article, allowing the master batch concentrate to be added at a rate of one part per hundred into virgin resin chip for the final extrusion. Higher concentrations of SQAC than this in the master batch concentrate could lead to difficulties in obtaining a homogeneous blend. In a further embodiment, the concentration of the SQAC in a master batch concentrate ranges from about 3 to about 30 wt. %, preferably about 5 to 20 wt. %, and more preferably about 8 to about 15 wt %, based on the total weight of the master batch concentrate.

The resin which can be used for master batching with SQAC, are preferably slightly higher in Intrinsic Viscosity (I.V.) than the virgin resin chip it will be blended with. This is due to two factors. First, the master batch resin is extruded one additional time compared to the virgin resin chip and this extra extrusion can cause a decrease in molecular weight due to the heat and mechanical shear on the polymer chain. Secondly, as the resin is compounded with higher amounts of SQAC, the mere dilution of monomeric SQAC into the molten polymer can cause a loss of tensile strength that may lead to shutdowns due to extrudate breakage at processing points which cannot be tolerated. In a preferred embodiment, the resin for master batching is 20% to 40% higher in IV than the virgin resin chip.

Incorporation of SQAC antimicrobials into polar polymers such as polyamides and polyesters produce well distributed, stable master batch concentrates at high concentrations of SQAC. For example, it is possible to produce, non-blooming 20 wt,% SQAC concentration in Nylon 6 that has good tensile strength and runs well on a twin screw compounding extruder. In this case, the SQAC can be uniformly distributed in the plastics without premixing it with plasticizers or pigments. The distribution can be checked by soaking the master batch chip in dilute bromophenol blue (BPB, 0.05% in water). The blue dye complexes with the nitrogen quat, thereby forming a permanent blue stain on the chip. The visual appearance of a continuous blue coating on the chip is evidence the SQAC has been uniformly distributed in the resin.

On the other hand, when SQAC is incorporated into non-polar polymers, such as polyolefins, it may be more difficult to produce uniform, stable master batch concentrates at high SQAC concentrations. Moreover, poor extrusion performance and/or poor distribution may result.

To increase the concentration of SQAC uniformly dispersed in non-polar plastics for purposes of master batching, polar copolymers of the homopolymer being compounded can be incorporated as compatibility enhancers to prevent surface blooming and leaching. See, for example, U.S. Pat. No. 6,979,455. However, the '455 patent's primary goal was to disperse high concentrations of more toxic 2,4,4′-trichloro-2′-hydroxy diphenol ether (TRICLOSAN) into polyethylene. It was a further goal of the '455 patent to retard leaching of TRICLOSAN into the environment. Although leaching was reduced, it was admittedly not eliminated. Therefore, in certain embodiments of the present invention, polar copolymers of the resin to be treated are used to enhance compatibility and uniform dispersion of SQAC, making it completely non-leaching after condensation polymerization curing.

For example, SQAC does not incorporate well into high density polyethylene (HDPE) at high enough concentrations to make master batching a desired option. Substituting more polar ethylene/methacrylate copolymer (EMAC) for some of the HDPE allows for the production of a stable, well dispersed, higher concentrations of SQAC in the mixed resin. The amount of copolymer used depends on the desired SQAC concentration and the tolerance of the plastic composition or the final end use article for the copolymer resin, and will be unique for each individual application. Therefore, it is left to those skilled in the art to optimize component ratios in the process.

The master batch concentrates can be pelletized into particulates or powders, as desired, e.g., having an average particle size ranging from submicron to several millimeters, depending on applications, and stored for future use in an environment free of moisture. The pellets can be used as is or mixed with SQAC-free resin pellets during thermoforming operation.

Stability of master batch concentrates relies heavily on the extent of the master batches exposed to moisture or humidity after the SQAC has been compounded into the resin. Therefore, care should be taken to fill containers full of the master batch concentrates, use moisture barrier linings and keep containers tightly sealed until used. After the master batch chip has been compounded into the virgin resin chip and the final textile fiber or any other plastic article has been formed, the normal exposure to ambient humidity will then cause the monomeric SQAC in the resultant mixture to polymerize. This condensation polymerization reaction can bond the SQAC with oxides and hydroxides in the plastic as well as allow the SQAC to undergo homopolymerization to form a three dimensional crosslinked network, thereby preventing leaching of the SQAC.

The advantages of this post extrusion polymerization or “cure” of SQACs include, but are not limited to:
Total immobilization of the SQAC in the plastic (totally non-leaching)
Improved physical properties such as tensile strength
Improved chemical resistance to oxidation, including chlorinated water
Improved chemical resistance to organic solvents, including boiling xylenes
Improved static charge dissipation
Improved resistance to heat

### Resin/Cellulosic Composite

Some of the synthetic organic polymers, copolymers and polymer blends described herein can also be processed by physically blending cellulose fibers as part of the formulation prior to compounding. The resultant compounded polymer/cellulose blend can then be hot formed into building materials, such as outdoor decking components, window frames and decorative molding that cut and nail like wood. In applications, these outdoor products are exposed to both weather and wear. In the absence of an antimicrobial compound incorporated into these polymer/cellulose hybrid composites, both surface and internal degradation, including discoloration and loss of structural strength, can occur due to microbial attack. On the other hand, addition of about 0.01 wt. % to about 5.0 wt. %, and preferably about 0.1 to about 4.0 wt. %, SQAC in the above mentioned building product formulations can provide totally non-leaching, immobilized, antimicrobial protection of the structural component.

Alkyl quaternary ammonium compounds and their coacervates with sodium lauryl sulfate have been shown to impart both lubricative and antimicrobial properties to extruded blends of polymers and cellulosics. See, for example, U.S. Pat. No. 7,582,694.

In certain embodiments of this invention, antimicrobial protection to the resin/cellulosic composites is provided by producing a composition of resin/cellulosic composites containing SQACs added during the compounding process. Examples of suitable cellulosic fibers include, but are not limited to, abaca, bamboo, coir, cotton, flax, hemp, jute, kapok, kenaf, pifia, raffia palm, ramie, sisal and wood. Cellulose is rich in hydroxyl groups and provides many excellent bonding sites for SQAC polymerization. SQACs exhibit excellent covalent bonding with the hydroxyls in cellulose. In one embodiment, the content of the cellulosic fibers in the resin/cellulosic composites ranges from about 20 wt. % to about 80 wt. %, preferably about 30 wt. % to about 70 wt. % and more preferably about 40 wt. % to about 60 wt. %.

Since the antimicrobial is uniformly distributed throughout the composite, surface wear will have no effect on the SQAC's ability to protect the product. Resin/cellulosic composite formulations used in the building industry, or for any extruded resin article, are unique formulations containing cellulose from wood, cotton and a variety of additional, natural sources, as well as many different polymers, copolymers and blends described herein. They may also contain fillers, pigments, anti-flammability agents and lubricants. Since each formulation is uniquely designed for a specific set of extrusion and end use conditions, it is left to those skilled in the art to optimize component ratios used in the process.

### Graft Copolymers

In certain embodiments of this invention, the plastic compositions are produced which show improved physical and chemical properties that are beneficial to end use applications by using mixtures of a vinyl or acrylic alkoxysilane and SQAC. Such properties include, for example, improved tensile strength, improved wear resistance, improved flexibility, static dissipation, and improved oxidative and chemical resistance along with antimicrobial protection.

Vinyl or acrylic alkoxysilanes may be grafted to nonpolar polymer, such as polyolefins, via either electron beam irradiation or reactions initiated by thermal decomposition of organic peroxides. For example, vinyltrimethoxysilane (VTMS) can be grafted to polyethylene using dicumyl peroxide, and then the silane-grafted polymer can be crosslinked with water. In addition, a soluble Lewis acid condensation catalyst, such as dibutyltin dilaurate, can be used. The combination of water and the acid catalyst hydrolyzes and condenses the —Si—OCH₃ linkage to form —Si—O—Si— crosslinks. As might be anticipated from the properties of silicone polymers, these crosslinks are highly heat resistant.

In certain embodiments, a polymer is mixed with an SQAC antimicorbial, a vinyl or acrylic alkoxysilane, and a peroxide in an inert atmosphere to prepare a graft polymer, e.g., by using a compounding extruder or mixer. Examples of suitable vinyl or acrylic alkoxysilanes include, but are not limited to, vinyltrimethoxysilane (VTMS), vinyltriethoxysilane (VTES), acryloxypropyltrimethoxysilane and methacryloxypropyltrimethoxysilane. The vinyl or acrylic alkoxysilane may be added in an amount ranging from about 0.5 wt. % to about 10 wt. %, preferably about 1 wt. % to about 6 wt. %, and more preferably of about 2 wt. %, based on the total weight of the mixture. Examples of suitable peroxides include, but are not limited to, those which are soluble in the polymer, such as dicumyl peroxide, tertiary butyl hydroperoxide, benzoyl peroxide, and pinane hydroperoxide. The peroxide may be added in an amount ranging from about 0.05 wt. % to about 0.30 wt. %, and preferably about 0.1 wt. % to about 020 wt. %, based on the total weight of the mixture. In one embodiment, the SQAC and the vinyl or acrylic alkoxysilane is premixed in weight ratios from 1:10 to 10:1 to form a solution, prior to blending and extruding with the plastic and the peroxide to form a crosslinkable mixed silane graft polymer that is chemically bound to the polymer.

The resultant crosslinkable graft polymer can be pelletized and stored for later use in containers such as foil-lined bags, under an inert, dry gas to prevent premature crosslinking and may be stable for several months.

Meanwhile, a master batch concentrate of the polymer is also prepared containing a condensation catalyst. Suitable condensation catalysts include a variety of catalysts which can initiate and accelerate condensation cure, and are substantially soluble in the polymer, for example, amines including aminopropylsilane derivatives; carboxylic acid salts of lead, tin and zinc; organic salts of iron, cadmium, barium, antimony, zirconium and cadmium; tin (II) octoates, laureates and oleates, as well as the salts of dibutyl tin. Strong acids (Bronsted and Lewis types) and bases can also effect condensation, but the reaction is difficult to control. Of great importance is good solubility of the condensation catalyst in the plastic used. In one embodiment, the condensation catalyst is dibutyltin dilaurate. The condensation catalyst may be added in an amount ranging from about 0.1 wt. % to about 2 wt. %, preferably about 0.5 wt. % to about 1.5 wt. %, and more preferably about 1 wt. %, based on the total weight of the mater batch concentrate. In addition, an antioxidant, pigment or other additives may be optionally added in the master batch concentrate, especially when they are desired in the plastic composition or the end use product.

In one embodiment, the master batch concentrate further contains a primary antioxidant and a secondary antioxidant. Examples of suitable primary antioxidants include a hindered phenol, such as commercially available Irganox® 1010 (pentaerythritol tetrakis (3-(3′,5′-di-tert-butyl-4′-hydroxyphenyl)), 1076 and B215. Examples of suitable secondary antioxidants include phosphates, such as commercially available Irgafos®. 168 (tris(2,4-di-tert)-butylphenyl)phosphite), and Irganox® PS 802. The primary and secondary antioxidants each may be used in an amount ranging from about 0.05 wt. % to about 2.0 wt. %, based on the total weight of the master batch concentrate. Moreover, a hindered amine light (UV) stabilizer such as Tinuvin® 111 and pigments, such as titanium dioxide or carbon black, may also be used. These additives can be added in amounts which do not interfere with the process and/or adversely affect the desired properties of the plastic composition. The catalyst master batch can be pelletized for ease of mixing with the grafted polymer in a conventional extruder.

The graft polymer and the master batch concentrate can be combined in a specific ratio, melted and mixed together and extruded. The mixture exits the extruder and is optionally cooled. The resultant extruded blend can then easily be crosslinked by exposure to water or steam to facilitate the crosslinking of the silyl groups. In one embodiment, the graft polymer and the master batch concentrate are pellet blended, e.g., in a 95:5 weight ratio of graft polymer to master batch concentrate.

After crosslinking the polymer with water, the resultant plastic composition demonstrates the following improved properties:
Total immobilization of the SQAC in the plastic (totally non-leaching)
Improved physical properties such as tensile strength
Improved chemical resistance to oxidation, including chlorinated water
Improved chemical resistance to organic solvents, including boiling xylenes
Improved static charge dissipation
Improved resistance to heat

Examples of suitable polymers for this coupling technique include all densities of polyethylene, ethylene vinyl acetate and ethylene/propylene (EPM) elastomer. Ethylene/propylene terpolymer (EPDM) hinders the graft reaction due to competition for the free radicals generated. Further, if fillers are used that have a high concentration of hydroxyl groups, such as certain carbon blacks or aluminum trihydrate, increased concentrations of vinyl or acrylic alkoxysilane can be used to overcome the hindering of the crosslinking reaction by the fillers.

Typical crosslinked polyethylene (PEX) can be prepared using any suitable process, e.g., the Sioplas process and the Monosil process. In the Sioplas process, a polyethylene resin is melted and vinyltrimethoxysilane (VTMS) or vinyltriethoxysilane (VTES) is added to the melted polyethylene along with a catalyst, such as a peroxide initiator, to form a graft resin. Functional reaction sites are thereby formed on the polyethylene polymer chains at which crosslinking will occur, e.g., by exposure to moisture. PEX has improved resistance to hot organic solvents and oxidizing agent such as chlorinated water.

Compared to the above described typical PEX preparation process, incorporation of SQAC into a process for the manufacture of crosslinked polyethylene (PEX) requires no processing changes other than a step of pre-dissolving the SQAC into vinyl or acrylic alkoxysilane prior to extrusion. Moreover, the extrusion formulae may also contain fillers, pigments, lubricants and other additives depending on the extrusion conditions and desired end use properties. Since each formulation is uniquely designed for a specific set of extrusion and end use conditions, it is left to those skilled in the art to optimize component ratios used in the process.

Having described the details of the invention above, various aspects of the present invention will now be described in greater detail by way of specific, non-limiting examples. These examples are offered for further clarity, and are not meant to limit the scope of claims of the invention.

### EXAMPLE 1

### Master Batch Concentrates of SQAC in HDPE/EMAC Resin

Example 1 demonstrates a viable process to produce resin pellets uniformly dispersed with SQAC into polyethylene/methyl acrylate resin (EMAC) by starting with an antimicrobial concentrate resin (master batch). The SQAC used was 3-(trimethoxysilyl)propyl-N-octadecyl-N,N-dimethyl ammonium chloride (Marquat), SQAC Ref #1 from Table III above.

Equipment Used for Examples:
TSE 21 mm Twin Screw Extruder 36:1 L/D (MB Screw Design)
Single Hole Strand Die
Ktron Loss in Weight feeder T20
6 ft. long Water Bath
Scheer Bay Pelletizer

EMAC resin pellets and 10% SQAC by weight were extruded to produce a master batch concentrate. Uniform dispersion was accomplished by pretreating EMAC pellets with a spray of 70% methanolic solution of SQAC followed by evaporation of the methanol. A portion of this master batch concentrate was then dry blended with high density polyethylene (HDPE)/EMAC and then re-extruded to make uniform pellets at 5 wt. % and 1 wt. % SQAC concentrations.

TRICLOSAN, a common trichlorinated diphenyl ether antimicrobial, was also compounded with EMAC at 10 wt. % in EMAC and a portion of the pellets was dry blended with HDPE/EMAC resin and re-extruded to make 1 wt. % TRICLOSAN pellets. The following table summarizes the compositions of the extrusion trial runs:

TABLE V

| | | | Extrusion |
|---|---|---|---|
| Run # | Composition | Name | Temp |
| 1 | EMAC Resin Only | Control | 250° F. |
| 2 | 10% TRICLOSAN/90% | Master Batch | 250° F. |
| | EMAC | | |
| 3 | 1% TRICLOSAN/49% | Final Product | 330° F. |
| | EMAC/50% HDPE | | |
| 4 | 10% Marquat/90% | Master Batch | 250° F. |
| | EMAC | | |
| 5 | 1% Marquat/49% | Final Product | 330° F. |
| | EMAC/50% HDPE | | |
| 6 | 5% Marquat/45% | Master Batch or | 330° F. |
| | EMAC/50% HDPE | Final Product | |

All 6 extrusion runs produced a rope-shaped product of about 3 mm in diameter that was cooled in a water trough then fed through a rotary chopper to produce about 1 lb of 3-6 mm length pellets. All runs worked mechanically well except run #4 where some difficulty was encountered due to the rope breaking and the chopper clogging. When the SQAC concentration was reduced to 5 wt. % in run #6, these problems disappeared. Maximum SQAC loading is dependent primarily upon the Intrinsic Viscosity of the resins being used as well as the distribution of the SQAC in the resin. The maximum SQAC loading in this system is, therefore, somewhere between about 5 wt. % and about 10 wt. % loading.

Antimicrobial Effectiveness Testing of Example 1 Resins

A portion of the above prepared pellets were pressed into 6″ diameter flexible wafers of about 2 mm thick for antimicrobial effectiveness testing (AETs) using ASTM D 6329-98 “Standard Guide for Developing Methodology for Evaluating the Ability of Indoor Materials to Support Microbial Growth Using a Static Environmental Chamber”. All bacteria concentrations given below are in Colony Forming Units/sq. in. (CFU/sq. in.)

The 1st AET set used wafers from runs 1, 2 and 4 above (Master Batch Concentrates) and tested for surface bacteria reducing efficiency. The challenge bacteria was Staphylococcus aureus and the applied concentration was 9×10⁴ CFU/sq. in. The bacteria was applied to a ceramic tile surface (4 sq. in.) and the same sized wafer was placed over the inoculated surface and left in contact at room temperature (RT) for 30 and 60 min, respectively, then swabbed and plated to determine the final bacteria concentration. Results are below:

TABLE VI

| | Final Bacteria | | |
|---|---|---|---|
| | Concentration after | | Average |
| Sample | 30 min | 60 min | % Kill |
| Run #2 (10% TRICLOSAN) | 9.0 × 10² | 8.0 × 10² | 98.7 |
| Run #4 (10% Marquat) | 8.0 × 10¹ | 9.0 × 10¹ | 99.9 |
| Run #1 (Control/EMAC | 9.3 × 10⁴ | NA | 0 |
| Resin Only) | | | |

The 2nd AET set used wafers from runs 3 and 5 above. These are 1 wt. % antimicrobial concentrations make by co-extruding their respective Master Batches at 10 wt. % antimicrobial concentration with virgin EMAC and HDPE to obtain the compositions listed in Table V. The wafers from runs 3 and 5 were tested for surface bacteria reducing efficiency. The challenge bacteria were Staphylococcus aureus and the applied concentration was 9×10⁴ CFU/sq. in. The bacteria was applied to a ceramic tile surface (4 sq. in.) and the same sized wafer was placed over the inoculated surface and left in contact at room temperature for 15, 30 and 60 min, then swabbed and plated to determine the final bacteria concentration. Results are below:

TABLE VII

Average % Kill after

| Run | Composition | 15 min | 30 min | 60 min |
|---|---|---|---|---|
| 3 | 1% TRICLOSAN/49% | 88.2 | 88.9 | 88.9 |
| | EMAC/50% HDPE | | | |
| 5 | 1% Marquat/49% | 87.0 | 90.1 | 90.3 |
| | EMAC/50% HDPE | | | |

### Zone of Inhibition Testing AATCC-147 (Modified) of Example 1 Resins

A set of AETs run measured Zone of Inhibition, ZOI (AATCC-147) and pellets from runs 1 to 5 were used. Pellets were placed in an agar growth medium that had been streaked with parallel lines of Staphylococcus aureus and incubated for 24 hours at 37° C. The final plates were photographed and measured for length of ZOI in mm. The results are below:

TABLE VIII

| Run # | Pellet Composition | ZOI (mm) |
|---|---|---|
| 1 | EMAC Resin Only | 0 |
| 2 | 10% TRICLOSAN/90% EMAC | 16 |
| 3 | 1% TRICLOSAN/49% EMAC/50% HDPE | 10 |
| 4 | 10% Marquat/90% EMAC | 0 |
| 5 | 1% Marquat/49% EMAC/50% HDPE | 1 |

After these ZOI results were obtained, it became clear that SQAC showed no ZOI because it had chemically bonded to the substrate polymer via the condensation polymerization of the reactive silyl groups to form a water insoluble polymer matrix and was non-leaching in the aqueous agar nutrient. As there is no leaching, there is no environmental pollution and no loss of antimicrobial effectiveness.

TRICLOSAN, like most other antimicrobials used today, shows a significant ZOI, indicating the antimicrobial is leaching into the agar at a high enough rate to kill the surrounding Staphylococcus aureus. This leaching characteristic not only depletes the antimicrobial from the plastic, but pollutes the environmental area around the plastic as well.

To confirm the non-leaching of SQAC impregnated plastic resins, pellets of all 6 runs were slurried in distilled water for 16 hours at 60° C. Since SQAC is an ionic compound, even ppm quantities of leached SQAC will result in a rise in the conductivity of the distilled water. It was determined from conductivity measurements that none of the starting SQAC was extracted into distilled water under these conditions.

Samples of antimicrobial resin from runs 3 and 5 were shaped into dog bones for Instron Tensile testing. Run 5 containing 1 wt. % SQAC had a uniform 12% increase in tensile strength compared to run 3 containing 1 wt. % TRICLOSAN. This is due to the added strength of the three dimensional crosslinked silane polymer formed as a result of SQAC exposure to water or water vapor. Normal ambient humidity can initiate this condensation polymerization, while exposure of the plastic to hot water or steam will hasten it.

A sample of antimicrobial resin from run 5 was checked for uniform distribution of SQAC both inside the chip and on the surface of the chip using bromophenol blue dye. If the SQAC is uniformly distributed, the chip retains a continuous blue coating that cannot be removed by water washing. Both the surface of the chip and the interior of sliced chips demonstrated a continuous coating indicative of complete uniform distribution of the SQAC throughout the extruded resin.

### Example 2

### Master Batch Concentrates of SQAC into Textile Fiber Grade Polyethylene Terephthalate (PET), Nylon 6,6 and Nylon 6 Resin Chip

Example 2 demonstrates viable processes to produce resin pellets uniformly dispersed with SQAC into fiber grade polyethylene terephthalate, Nylon 6,6 and Nylon 6 (polycaprolactam) by first extruding an antimicrobial concentrate (Master Batch), then co-extruding the master batch with additional virgin chip. The SQAC used was 3-(trimethoxysilyl)propyl-N-octadecyl-N,N-dimethyl ammonium chloride, Compound Ref #1 from Table III above. The extrusion equipment used was the same as used for Example 1.

The PET chip was dried overnight at 220° F. The Nylon was dried for 4 hours at 180° F. All runs used the hindered phenol antioxidant Irganox B215 at 0.5 wt. % based on the weight of resin since the extrusion temperatures for these resins are higher than in Example 1, at 540° F. for PET and Nylon 6,6, and 490° F. for Nylon 6.

The SQAC used for runs 7-19 was metered simultaneously into the extruder hopper with the resin chip as a 54 wt. % active powder in TiO₂. The TiO₂ powder is added to the SQAC solution in methanol. The methanol is then stripped, leaving a non-waxy, powder that has excellent flow properties for metered addition. This technique of SQAC isolation and addition is valuable especially when the final resin composition requires TiO₂, for example, as a pigment.

Runs 7-13 were used to determine the effect of increasing the SQAC concentration in the resin on the extrusion mechanics and color of the extruded antimicrobial resin. Similarly, runs 14-19 studied the same effects using Nylon 6,6. In all runs, the extruded antimicrobial plastic extruded well and color was nearly the same as the virgin chip.

TABLE IX

| | | | | SQAC (g @ | Irganox |
|---|---|---|---|---|---|
| | | Chip Weight | % SQAC | 54 wt. % in | B215 |
| Run # | Chip | (lbs) | in Chip | TiO₂) | (g) |
| 7 | PET | 4.00 | 0 | 0 | 22.7 |
| 8 | PET | 4.00 | 0.25 | 8.4 | 9.1 |
| 9 | PET | 4.00 | 0.50 | 16.8 | 9.1 |
| 10 | PET | 4.00 | 1.00 | 33.6 | 9.1 |
| 11 | PET | 4.00 | 3.00 | 100.8 | 9.1 |
| 12 | PET | 4.00 | 2.50 | 84 | 9.1 |
| 13 | PET | 4.00 | 5.00 | 168 | 9.1 |
| 14 | Nylon 66 | 4.00 | 0 | 0 | 9.1 |
| 15 | Nylon 66 | 4.00 | 0.25 | 8.4 | 9.1 |
| 16 | Nylon 66 | 3.00 | 0.50 | 12.6 | 6.8 |
| 17 | Nylon 66 | 2.00 | 1.00 | 16.8 | 4.6 |
| 18 | Nylon 66 | 2.00 | 3.00 | 50.4 | 4.6 |
| 19 | Nylon 66 | 2.00 | 5.00 | 84.0 | 4.6 |
| 20 | PET* | 3.00 | 0.15 | — | 6.8 |

*2.85 lbs of PET chip and 0.15 lbs of Run 13

In run 20, virgin PET chip was compounded with PET run 13 (2.85 lbs virgin PET/0.15 lbs run 13). The virgin chip was pre-blended with run 13 and fed into the main feed throat. The material ran well and the color of the final chip was indistinguishable from the color of the virgin chip. This 2^{nd} compounding represents how most fiber spinning plants making PET textile yarn would operate, bringing a master batch concentrate of SQAC in PET, then blending it at 1 wt. % to 10 wt. % with virgin chip and extruding the blend into fibers.

Extrusion runs 21-30 used SQAC that had been stripped of methanol without the presence of TiO₂ as a processing aid. Two active concentrations of SQAC were used: 95 wt. % and 99 wt. % of SQAC in methanol. The 95 wt. % SQAC had a melting point of 60° C. and the 99 wt. % SQAC melted at 130° C. The method of combining the SQAC with the resin chip prior to feeding the mixture into the extruder was to melt the SQAC in a microwave oven and pour the melt into a blend hopper containing the resin chip, followed by mixing. The resin chip picked up a fairly uniform coating of the molten SQAC using this mixing process.

Runs 21-30 (see Table X) demonstrate the SQAC loading level attainable for purposes of master batching. All runs showed good extrusion mechanics where the extruded 3 mm rope had good tensile strength when hot and did not break. After the rope was cooled through a 6 ft long water bath run at room temperature, the cooled rope was continuously fed into a chopper. The chopper worked well and did not foul even at 20 wt. % SQAC loading in runs 24 and 30 using Nylon 6,6 and Nylon 6, respectively. The achievement of acceptable extrusion mechanics at these high loading levels of SQAC improves the economics of the master batching concept since lower amounts of resin need to be extruded twice.

TABLE X

| | | Chip | wt. % SQAC in | 95 wt. % | Irganox |
|---|---|---|---|---|---|
| | | Weight | master batch | SQAC in | B215 |
| Run # | Chip Type | (lbs) | concentrate | methanol (g) | (g) |
| 21 | Nylon 6,6 | 2.0 | 8.0 | 72.6* | 4.6 |
| 22 | Nylon 6,6 | 2.0 | 8.0 | 72.6 | 4.6 |
| 23 | Nylon 6,6 | 2.0 | 12.0 | 109.0 | 4.6 |
| 24 | Nylon 6,6 | 1.0 | 20.0 | 90.8 | 2.3 |
| 25 | PET | 2.0 | 12.0 | 109 | 4.6 |
| 26 | PET | 2.0 | 6.0 | 54.5 | 4.6 |
| 27 | PET | 2.0 | 3.0 | 27.2 | 4.6 |
| 28 | Nylon 6 | 1.0 | 12.0 | 0 | 9.1 |
| 29 | Nylon 6 | 1.0 | 16.0 | 8.4 | 9.1 |
| 30 | Nylon 6 | 1.0 | 20.0 | 12.6 | 6.8 |
| | | Virgin | | Run #17 at | Irganox |
| | | Chip | wt. % SQAC | 12 wt. % | B215 |
| | | (lbs) | in Blend | SQAC (lbs) | (g) |
| MB1 | Nylon 6,6 | 0.950 | 0.60 | 0.050 | 2.3 |
| MB2 | Nylon 6,6 | 0.975 | 0.30 | 0.025 | 2.3 |
| MB3 | Nylon 6,6 | 0.850 | 0.77 | 0.058 | 2.0 |

*99 wt. % SQAC in methanol was used.

Runs MB1-MB3 are re-extruded blends of virgin chip and Master Batch run 23 at 12 wt. % SQAC loading to produce final products containing from 0.3 wt. % to 0.77 wt. % SQAC based on the total resin weight. The color and handling properties of these final products are identical to the virgin chip.

The Nylon 6,6 resin used above was DuPont Zytel 101 polyamide 66. The Nylon 6 used was DuPont Ultramid B 27 E 01 polyamide 6. The PET resin used was a proprietary Unifi textile fiber grade.

A portion of the pellets from runs 10, 13, 17 and 28 were pressed into 6 in. diameter flexible wafers of about 2 mm thick for antimicrobial effectiveness testing (AETs) using ASTM D 6329-98 “Standard Guide for Developing Methodology for Evaluating the Ability of Indoor Materials to Support Microbial Growth Using a Static Environmental Chamber”. All bacteria concentrations given below are in Colony Forming Units/sq. in. (CFU/sq. in.). The challenge bacteria were Staphylococcus aureus and the applied concentration was 4.7×10⁵ CFU/sq. in. The wafers were cut into 1 inch squares and inoculated with 0.5 ml of challenge suspension, then covered with a 2^{nd} 1 inch square of wafer to “sandwich” the challenge suspension. Six sandwiches were made from each sample to test 3 different aging times in duplicate. The % kill data of the samples are shown below:

TABLE XI

| | | SQAC | % Kill of Staphylococcus | | |
|---|---|---|---|---|---|
| | | Concentration | aureus after | | |
| Run # | Substrate | (wt. %) | 1 hr | 4 hrs | 24 hrs |
| 10 | PET | 1.0 | 68 | 70 | 96 |
| 13 | PET | 5.0 | 62 | 66 | 96 |
| 17 | Nylon 6,6 | 1.0 | 36 | 38 | 87 |
| 28 | Nylon 6 | 12.0 | >99.8 | >99.8 | >99.8 |

The above data shows effective kill rates for both PET and Nylon containing concentrations as low as 1 wt. % SQAC distributed throughout the plastic substrate and polymerized to form a totally non-leaching, environmentally friendly method of protecting these plastics from Staphylococcus aureus surface contamination.

To confirm the non-leaching quality of SQAC impregnated plastic resins, pellets of all Runs 7 to 30 were slurried in distilled water for 16 hrs at 60° C. Since SQAC is an ionic compound, even ppm quantities of leached SQAC will result in a rise in the conductivity of the distilled water. It was determined from conductivity measurements that none of the starting SQAC was extracted into distilled water under these conditions.

While the invention has been described with reference to specific embodiments, variations and modifications may be made without departing from the spirit and the scope of the invention. Such variations and modifications are to be considered within the purview and scope of the invention as defined by the appended claims.

All of the above-mentioned references are herein incorporated by reference in their entirety to the same extent as if each individual reference was specifically and individually indicated to be incorporated herein by reference in its entirety.

We claim:

1. An antimicrobial plastic composition suitable for a non-foam application comprising an antimicrobial compound uniformly dispersed in a plastic,
wherein the antimicrobial compound is selected from the group consisting of silanol quaternary ammonium compounds and salts thereof (SQACs) having a hydroxyl or hydrolyzable silane group capable of undergoing a condensation polymerization reaction to form a homo or copolymer and/or forming a covalent bond with the plastic and/or other components in the plastic resin, which optionally forms a homo or copolymer, and/or a covalent bond with the plastic and/or other components.

2. The composition of claim 1, wherein the plastic is a synthetic, thermoplastic or thermosetting polymer and/or resin, or a synthetic/natural composite thereof.

3. The composition of claim 1, wherein the antimicrobial compound is represented by the following general Formula I or II: 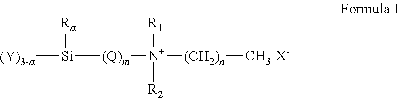
wherein:
Y is a hydroxyl or a hydrolyzable radical;
R is a hydroxyl or a monovalent hydrocarbon group;
a is 0 or 1;
Q is a divalent hydrocarbon group;
m is an integer from 1 to 20;
R₁ is an alkyl having 1 to 30 carbon atoms;
R₂ is a lower alkyl having 1 to 8 carbon atoms;
n is an integer from 6 to 30; and
X is a monovalent inorganic or organic radical or group selected from halogen; triiodide radical; alkoxy or ZSO₄, where Z is a monovalent hydrocarbon, —(CH₂—)_{b}—R₃, —(CH₂O)_{d}(CH₂—)_{b}—R₃, —(CH₂—)_{b}—COOR₃, where b is an integer of 2 to 24, d is an integer of 1 to 10, and R₃ is a monovalent hydrocarbon, 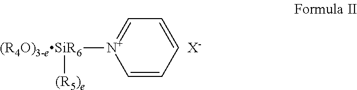
wherein:
R₄ is hydrogen or an alkyl having 1 to 4 carbon atoms;
e is an integer of 0 or 1;
R₅ is a lower alkyl, and preferably methyl or ethyl;
R₆ is an alkylene group of 1 to 4 carbon atoms; and
X is the same as defined in Formula I.

4. The composition of claim 3, wherein Y is hydroxyl, alkoxy or acyloxy; R is a lower alkyl or phenyl; Q is an alkylene or phenylene wherein the alkyl chain in the alkylene may be interrupted by one or more phenylene groups; and/or R₅ is methyl or ethyl.

5. The composition of claim 3, wherein Y is hydroxyl, methoxy or ethoxy; a is 0 or 1; R is methyl or ethyl; Q is methylene; m is 3; R₁ is methyl or alkyl having 10, 14 or 18 carbon atoms; R₂ is methyl; and/or X is Cl.

6. The composition of claim 1, wherein (a) the antimicrobial compound is 3-(trimethoxysilyl)propyl-N-octadecyl-N,N-dimethyl ammonium chloride, 3-(trimethoxysilyl)propyl-N-tetradecyl-N,N-dimethyl ammonium chloride, 3-(trimethoxysilyl) propyl-N,N-didecyl-N-methyl ammonium chloride, or 3-(trihydroxysilyl) propyl-N-octyldecyl-N,N-dimethyl ammonium chloride; and/or (b) the plastic is selected from the group consisting of polyolefins, polyethylene/acrylate copolymers, polyesters, polyamides, polyacrylate homo and copolymers, polyethers, phenoxy polymers, polystyrene and copolymers, polyacetal (polyoxymethylene) homo and copolymers, polycarbonate, polyethylene naphthalate, polyamide/imide, polybenzimidazole, fluoropolymers, synthetic rubbers, vinyl polymers, cellulose derivatives, Rayon and combinations thereof.

7. The composition of claim 6, wherein the antimicrobial compound is 3-(trimethoxysilyl)propyl-N-octadecyl-N,N-dimethyl ammonium chloride.

8. The composition of claim 6, wherein the plastic is selected from the group consisting of polyethylene, polypropylene, polybutylene, ethylene methyl acrylate, polyethylene terephthalate, polybutylene terephthalate, nylon 6, nylon 6,6, nylon 4,6, nylon 11, nylon 12, aramids, polymethylmethacrylate, polyether sulfone, polyetheretherketone, epichlorohydrin/bisphenol resins, polyacrylonitrile/butadiene/styrene (ABS), polycarbonate, polyethylene naphthalate, polyamide/imide, polybenzimidazole, ethylene-chlorotrifluoroethylene, ethylene/propylene/diene monomer (EPDM), chlorinated rubber, nitro rubber, styrene butadiene rubber, polyureathanes, polylactides, polyvinyl acetate and copolymers, polyvinyl butyral, polyvinyl chloride, cellulose acetate homopolymer and copolymers with cellulose propionate and cellulose butyrate, nitro cellulose, Rayon and combinations thereof.

9. A thermoformed, non-foamed article comprising the composition of claim 1, wherein the concentration of the antimicrobial compound is from about 0.01 wt. % to about 30 wt. %, based on the total weight of the article.

10. The thermoformed, non-foamed article of claim 9, wherein the concentration of the antimicrobial compound is from about 0.25 wt. % to about 14 wt. %, based on the total weight of the article.

11. A thermoformed, non-foamed article comprising the composition of claim 1, wherein the antimicrobial compound forms a covalent bond with the plastic and/or other components in the plastic composition.

12. A master batch concentrate comprising pellets of the composition of claim 1, wherein the concentration of the antimicrobial compound is from about 3 wt. % to about 30 wt. %, based on the total weight of the concentrate.

13. The composition of claim 1, wherein the composition further comprises (a) cellulosic fibers; and/or (b) a pigment, an antioxidant, a plasticizer or a filler.

14. The composition of claim 13, wherein the cellulosic fibers are present in an amount of about 20 wt. % to about 80 wt. %, based on the total weight of the cellulosic fibers and the plastic.

15. The composition of claim 1, wherein the composition further comprises titanium dioxide (TiO₂), calcium sulfate, calcium carbonate, carbon black, carbon fibers, cellulosic fibers, talc, or a combination thereof.

16. A textile fiber for yarn comprising the composition of claim 1.

17. The textile fiber of claim 16, wherein the plastic is made from polyethylene terephthalate (PET), nylon 6 or nylon 6,6.

18. A method for preparing an antimicrobial plastic composition suitable for a non-foam application, comprising:
(i) uniformly dispersing an antimicrobial compound in a plastic to form an antimicrobial plastic composition; and
(ii) thermoforming a shaped article from the antimicrobial plastic composition; and
(iii) optionally exposing the shaped article obtained in (ii) to moisture or steam,
wherein the antimicrobial compound is selected from the group consisting of silanol quaternary ammonium compounds and salts thereof (SQACs) having a hydroxyl or hydrolyzable silane group capable of undergoing a condensation polymerization reaction to form a homo or copolymer and/or forming a covalent bond with the plastic and/or other components in the plastic composition.

19. The composition of claim 18, wherein the antimicrobial compound is represented by the following general Formula I or II: 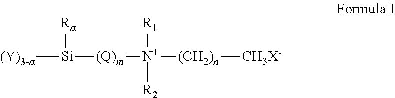
wherein:
Y is a hydroxyl or a hydrolyzable radical;
R is a hydroxyl or a monovalent hydrocarbon group;
a is 0 or 1;
Q is a divalent hydrocarbon group;
m is an integer from 1 to 20;
R₁ is an alkyl having 1 to 30 carbon atoms;
R₂ is a lower alkyl having 1 to 8 carbon atoms;
n is an integer from 6 to 30; and
X is a monovalent inorganic or organic radical or group selected from halogen; triiodide radical; alkoxy or ZSO₄, where Z is a monovalent hydrocarbon, —(CH₂—)_{b}—R₃, —(CH₂O)_{d}(CH₂—)_{b}—R₃, —(CH₂—)_{b}—COOR₃, where b is an integer of 2 to 24, d is an integer of 1 to 10, and R₃ is a monovalent hydrocarbon, 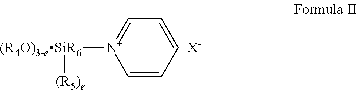
wherein:
R₄ is hydrogen or an alkyl having 1 to 4 carbon atoms;
e is an integer of 0 or 1;
R₅ is a lower alkyl, and preferably methyl or ethyl;
R₆ is an alkylene group of 1 to 4 carbon atoms; and
X is the same as defined in Formula I.

20. The method of claim 18, wherein (a) the antimicrobial compound is in a fluid state; or (b) the antimicrobial compound in a form of a liquid melt or a solution in a solvent is sprayed onto the plastic.

21. The method of claim 18, comprising compounding the antimicrobial compound into the plastic using a compounding extruder.

22. The method of claim 21, further comprising blending the antimicrobial compound with the plastic prior to compound extrusion.

23. The method of claim 22, wherein the antimicrobial compound is blended as a liquid melt with the plastic prior to extrusion.

24. The method of claim 18, further comprising premixing the antimicrobial compound with a powdered additive comprising a pigment, an antioxidant, a plasticizer and/or a filler, prior to (i).

25. The method of claim 24, wherein (a) the powdered additive comprises titanium dioxide (TiO₂), calcium sulfate, calcium carbonate, carbon black, carbon fibers, cellulosic fibers, talc, or a combination thereof; (b) the powdered additive has an average particle size ranging from submicron to several millimeters; and/or (c) the concentration of the antimicrobial compound is from about 30 wt. % to about 70 wt. %, based on the total weight of the antimicrobial compound and the powdered additive.

26. The method of claim 18, wherein the concentration of the antimicrobial compound is from about 0.01 wt. % to about 30 wt. %, based on the total weight of the plastic composition.

27. The method of claim 18, further comprising preparing a master batch concentrate by blending the antimicrobial compound with a resin, prior to (i), wherein the concentration of the antimicrobial compound in the master batch concentrate is higher than the concentration of the antimicrobial compound in the plastic composition.

28. The method of claim 27, wherein (a) the concentration of the antimicrobial compound in the master batch concentrate is from about 3 wt. % to about 30 wt. %, based on the total weight of the master batch concentrate; (b) the resin has a higher Intrinsic Viscosity value than the plastic; and/or (c) the resin is a polar copolymer of the plastic.

29. The method of claim 28, wherein the plastic is polyethylene, and the copolymer is ethylene/methyl acrylate resin.

30. The method of claim 18, wherein the plastic composition further comprises cellulosic fibers.

31. The method of claim 30, wherein the cellulosic fibers comprises cellulose derived from wood or cotton, and/or the plastic is a polyolefin or copolymer thereof.

32. The method of claim 31, wherein the polyolefin is polyethylene.

33. A method for preparing an antimicrobial plastic composition suitable for a non-foam application, comprising:
(i) preparing a graft polymer by mixing a polymer with an antimicrobial compound, a vinyl or acrylic alkoxysilane, and a peroxide,
(ii) preparing a master batch concentrate by mixing the polymer with a condensation catalyst,
(iii) uniformly mixing the master batch concentrate and the graft polymer and thermoforming the mixture into a shaped article, and
(iv) optionally exposing the shaped article obtained in (iii) to moisture or steam,
wherein the antimicrobial compound is selected from the group consisting of silanol quaternary ammonium compounds and salts thereof (SQACs) having a hydroxyl or hydrolyzable silane group capable of undergoing a condensation polymerization reaction to form a homo or copolymer and/or forming a covalent bond with the plastic and/or other components in the plastic composition.

34. The method of claim 33, wherein (a) the vinyl or acrylic alkoxysilane is vinyl trimethoxysilane, vinyl triethoxysilane, acryloxypropyltrimethoxysilane or methacryloxypropyltrimethoxysilane; (b) the polymer is polyethylene, ethylene vinyl acetate or ethylene/propylene (EPM) rubber; (c) the antimicrobial compound is represented by the following general Formula I or II: 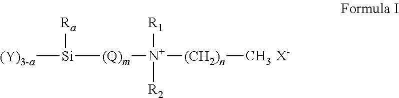
wherein:
Y is a hydroxyl or a hydrolyzable radical;
R is a hydroxyl or a monovalent hydrocarbon group;
a is 0 or 1;
Q is a divalent hydrocarbon group;
m is an integer from 1 to 20;
R₁ is an alkyl having 1 to 30 carbon atoms;
R₂ is a lower alkyl having 1 to 8 carbon atoms;
n is an integer from 6 to 30; and
X is a monovalent inorganic or organic radical or group selected from halogen; triiodide radical; alkoxy or ZSO₄, where Z is a monovalent hydrocarbon, —(CH₂—)_{b}—R₃, —(CH₂O)_{d}(CH₂—)_{b}—R₃, —(CH₂—)_{b}—COOR_{S}, where b is an integer of 2 to 24, d is an integer of 1 to 10, and R₃ is a monovalent hydrocarbon, 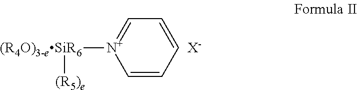
wherein:
R₄ is hydrogen or an alkyl having 1 to 4 carbon atoms;
e is an integer of 0 or 1;
R₅ is a lower alkyl, and preferably methyl or ethyl;
R₆ is an alkylene group of 1 to 4 carbon atoms; and
X is the same as defined in Formula I;
(d) the peroxide comprises dicumyl peroxide, tertiary butyl hydroperoxide, benzoyl peroxide, or pinane hydroperoxide; and (e) the condensation catalyst comprises at least one selected from the group consisting of amines, carboxylic acid salts of lead, tin and zinc; organic salts of iron, cadmium, barium, antimony, zirconium and cadmium; tin (II) octoates, laureates and oleates, and salts of dibutyl tin.
